(19) United States
(12) Patent Application Publication
(10) Pub. No.: US 2013/0104456 A1
(43) Pub. Date: May 2, 2013

(54) VERTICAL GARDEN SYSTEMS AND METHODS

(71) Applicant: Trevor L. Smith, Arlington, MA (US)

(72) Inventor: Trevor L. Smith, Arlington, MA (US)

(21) Appl. No.: 13/628,209

(22) Filed: Sep. 27, 2012

Related U.S. Application Data
(60) Provisional application No. 61/539,619, filed on Sep. 27, 2011.

(51) Int. Cl. A01G 9/02

(52) U.S. Cl. CPC A01G 9/022; A01G 9/02; A01G 9/025
USPC 47/66.6; 47/83; 47/82; 47/86; 47/66.7

(57) ABSTRACT

Described are a vertical garden system and method. A mounting panel includes a plurality of first mounting attachment mechanisms. A planting cell module is positioned on a surface of the mounting panel. The planting cell module has a second mounting attachment mechanism constructed and arranged for removably coupling with a first mounting attachment mechanism. The planting cell module has an interior volume in which a plant component is positioned.

### FIELD OF THE INVENTION

The present invention relates to the field of landscape and garden design, and more specifically, to systems and methods for vertical gardening.

### BACKGROUND

As part of the ongoing industrialization of modern society, the human population continues to increase. In doing so, the amount of real estate available to build, live, and work continues to decrease. Moreover, urban expansion has resulted in the reduction of forests and agricultural land, as well as increased pollution, garbage, traffic congestion, and a general degradation of the environment, such as the destruction of forests and the obstruction of natural vistas, such as mountains, fields, and so on.

The continued urbanization and corresponding environmental degradation has generated a desire to provide urban green space within cities, towns, as well as buildings, shopping malls, and other concrete environments.

### BRIEF SUMMARY

In one aspect, providing is a vertical garden system, comprising: a mounting panel, the mounting panel including a plurality of first mounting attachment mechanisms; and a planting cell module positioned on a surface of the mounting panel. The planting cell module has a second mounting attachment mechanism constructed and arranged for removably coupling with a first mounting attachment mechanism of the plurality of first mounting attachment mechanism. The planting cell module has an interior volume in which a plant component is positioned.

In another aspect, provided is a planting cell module, comprising a cube-shaped body. The body including a rear surface and an exposed front region opposite the rear surface. The module further comprises at least one first attachment mechanism at the rear surface that is constructed and arranged for removably coupling with a second attachment mechanism at a mounting panel; and an interior volume in the body. A plant component is positioned in the interior volume.

In another aspect, provided is a method for forming a living wall, comprising: positioning a mounting panel at a wall, the mounting panel including a plurality of first attachment mechanisms; coupling a planting cell module to at least one first attachment mechanism of the plurality of mounting tab, the planting cell module having at least one second attachment mechanism that communicates with the at least one first attachment mechanism for holding the planting cell module in place against the mounting panel; and positioning a plant component in an interior volume of the planting cell module, at least a portion of the plant component extending in a direction that is transverse with respect to the mounting panel and that is viewed from an opening of the planting cell module.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a vertical garden system, in accordance with an embodiment;

FIG. 2A is a front view of a mounting panel, in accordance with an embodiment;

FIG. 2B is a front view of an array of planting cell modules attached to the mounting panel of FIG. 2A, in accordance with an embodiment;

FIG. 2C is a front view of a plurality of planting cell modules attached to the mounting panel of FIG. 2A, in accordance with an embodiment;

FIG. 3A is a side view of the mounting panel of FIG. 2, in accordance with an embodiment;

FIG. 3B is a front view of the mounting panel of FIGS. 2 and 3A, taken along line A-A′;

FIG. 3C is a perspective view of a core of the mounting panel of FIGS. 2, 3A and 3B;

FIG. 4 is a perspective view of a planting cell module, in accordance with an embodiment;

FIG. 5 is a perspective view of a body of a planting cell module, in accordance with an embodiment;

FIG. 6 is a cutaway perspective view of a planting cell module, in accordance with an embodiment;

FIG. 7A is a perspective view of a planting cell module, in accordance with an embodiment;

FIG. 7B is a rear view of the planting cell module of FIG. 7A;

FIG. 8A is a perspective view of a planting cell module, in accordance with another embodiment;

FIG. 8B is a rear view of the planting cell module of FIG. 8A;

FIG. 9A is a cutaway perspective view of the vertical garden system of FIG. 1, in accordance with an embodiment;

FIG. 9B is a cutaway closeup view of the vertical garden system of FIGS. 1 and 9A;

FIG. 10A is a closeup side view of a planting cell module in communication with a mounting tab having a locking ridge, in accordance with an embodiment;

FIG. 10B is a closeup side view of a planting cell module in communication with a mounting tab having another locking ridge, in accordance with an embodiment;

FIG. 11A is a top view of a drip pan, in accordance with an embodiment;

FIG. 11B is a rear view of a drip pan, in accordance with an embodiment;

FIG. 11C is a cutaway rear view of the drip pan of FIGS. 11A and 11B;

FIG. 12 is a perspective view of a catch basin, in accordance with an embodiment;

FIG. 13A is a front view of a vertical garden system in which water flows through elements of the vertical garden system;

FIG. 13B is a cross-sectional front view of a drip pan in which water is collected, wherein a portion of the water is removed from the drip pan via a plurality of weep holes, in accordance with an embodiment;

FIG. 13C is a cross-sectional side view of the vertical garden system, in accordance with an embodiment;

FIG. 14 is a perspective view of a vertical garden system, in accordance with another embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

One approach that attempts to address space concerns while providing a green, aesthetic environment includes the implementation of ecologically friendly vertical gardens, also referred to as living walls, green walls, sky farms, or urban gardens. Vertical gardens are well-suited for urban environments where ground space is limited but vertical space is plentiful. Recent studies have determined that plants absorb harmful volatile organic compounds such as formaldehyde and benzene from the air, and can reduce or eliminate physical or mental health of building occupants. Living walls can also alleviate air pollution, reduce noise pollution, and counteract effects associated with urban heat islands. Living walls can be used in verticulture environments, where food is grown in small spaces and in urban settings where soil conditions can be otherwise undesirable, or possibly toxic.

Embodiments of the present inventive concepts include a modular vertical garden system comprising an insulated mounting panel and one or more planting cells removably attachable to the mounting panel. The mounting panel in turn can be attached a vertical surface such as a wall. Each planting cell can include one or more plants or related living organisms. Plants, pre-germinated seeds, soil, and related planting components can be inserted in a standalone planting cell, which can subsequently be plugged into the vertically-positioned mounting panel. More specifically, each planting cell includes one or more female sockets in which a mounting tab extending from the mounting panel can be inserted. Planting cells can be grouped together to form an aesthetically pleasing configuration. Planting cells can be removed from the mounting panel for replacing a plant, soil, or other planting components, or for rearranging the planting cells at different locations on the mounting panel, then reinserted at the mounting panel. A plant can be potted in each cell of the living wall system prior to installation. Users can select plants they enjoy to create their own wall design or garden, while reducing the mess and learning curve of transplanting plants from their pots to the system.

Food plants can be started from seed and mounted after they have sprouted. This concept aids in maintenance by providing the ability to change out an individual plant without removing the entire unit. The new plant is already rooted in the cell, eliminating the risk of replacement plants falling out of the system. New crops can be easily rotated into the system once older crops have run their course.

The living wall system can also include drip pan and catch basin that are fitted at the top and bottom of the mounting panel using the same or similar mounting tabs and locking ridge system as the modular planting cells. The drip pan and catch basin are configured to irrigate the contents of the planting cells, for example, a plant or other vegetation. In this manner, uninterrupted flow paths can be formed from the drip pan to the catch basin, permitting the planting cells between the drip pan and the catch basin to receive water for their contents. Drip hoses can extend between the cells with an emitter placed intermittently in proximity with the cells. An optional frame can be coupled to the mounting panel for providing aesthetic and/or decorative appeal to a viewer, for example, living art.

Accordingly, embodiments include a hyper-modular design providing the ability to mount each compartment or cell is mounted individually rather than in large sections, which aids in maintenance by providing the ability to change out an individual plant without removing the entire unit. Conventional configurations having large compartmentalized panels or boxes, on the other hand, render maintenance or design changes difficult because a user must remove large portions of the wall to make any changes or replace dead plants. In accordance with an embodiment, a new plant can be rooted in the cell, eliminating the risk of replacement plants falling out of the system. New crops can be easily rotated into the system once older crops have expired.

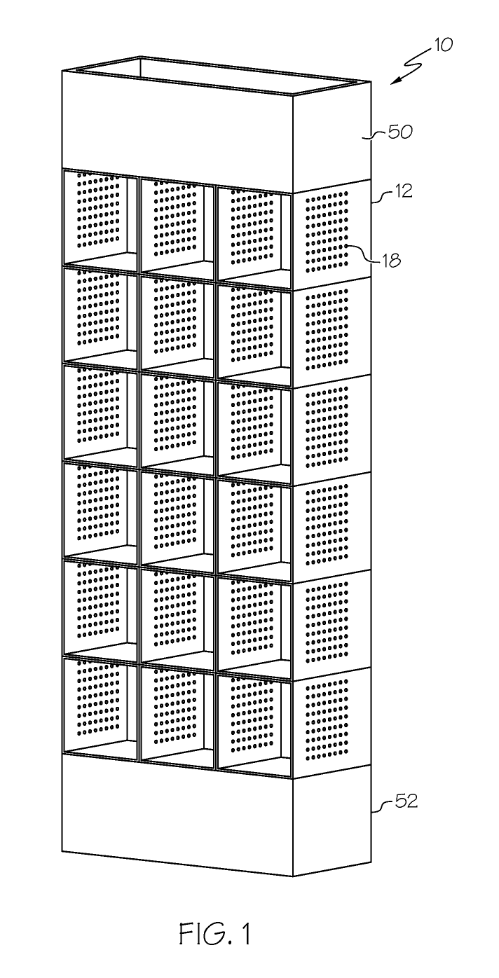

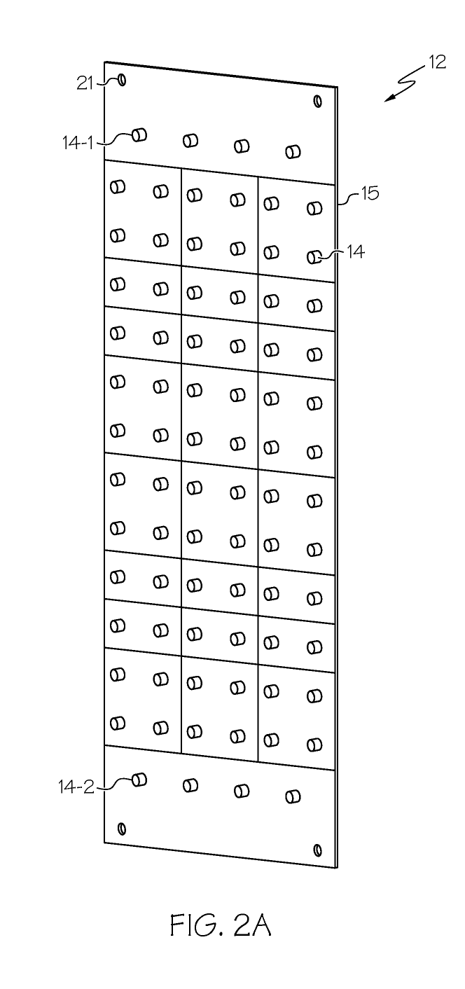

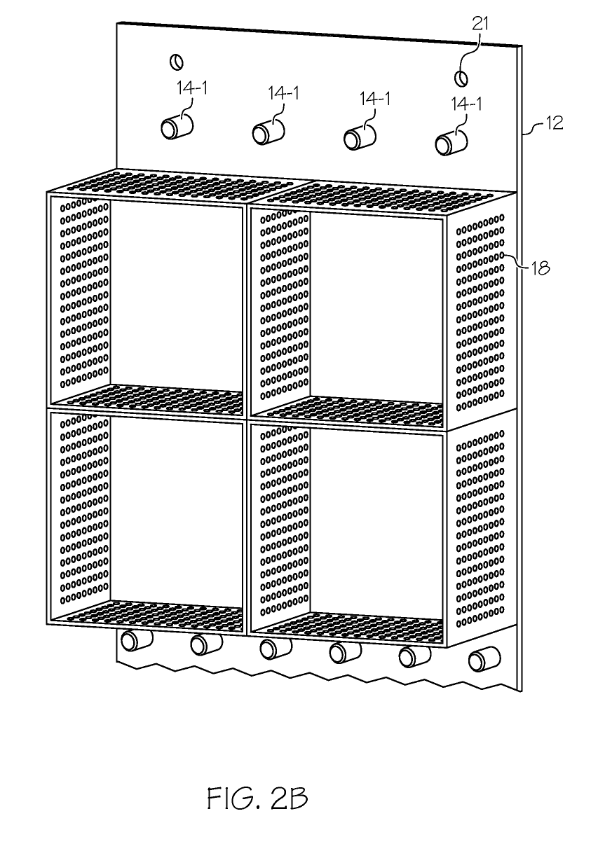

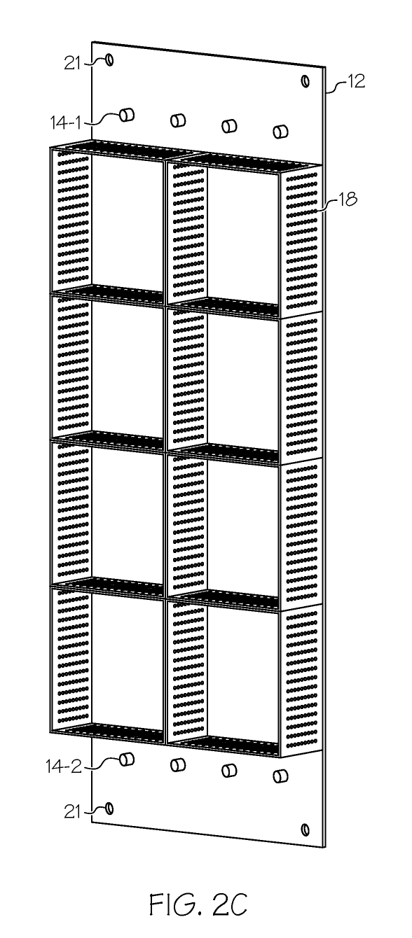

FIG. 1 is a perspective view of a vertical garden system 10, in accordance with an embodiment. The vertical garden system 10 includes a plurality of planting cells 18, or planting cell modules removably coupled to a mounting panel 12. The planting cell modules 18 can be arranged on the mounting panel 12 as an array of rows and columns, or other pattern or arrangement. The mounting panel 12 can be attached to a wall or other surface using screws or other attachment mechanisms inserted through openings 21 in the mounting panel 12, as shown in FIGS. 2A-2C.

A drip pan 50 can be attached to a top region of the mounting panel 12. The drip pan 50 can have a length that is the same as or similar to that of a row of planting cell modules 18 adjacent the drip pan 50, for example, shown in FIG. 1. In this manner, the drip pan 50 can provide water or other nutrients to at least one row of planting cell modules 18 positioned under the drip pan 50.

A catch basin 52 can be attached to a bottom region of the mounting panel 12. The drip pan 50 can have a length that is the same as or similar to that of a bottom row of planting cell modules 18 adjacent the catch basin 52, for example, shown in FIG. 1. In this manner, the catch basin 52 can receive excess water and the like from planting cell modules 18 positioned above the catch basin 52.

FIG. 2A is a front view of a mounting panel 12, in accordance with an embodiment. In an embodiment, the mounting panel 12 is formed of a single sheet, for example, formed by injection molding or other prefabrication technique. Alternatively, the mounting panel 12 can be formed by machining. Accordingly, the mounting panel 12 can be formed of metals, plastics, or other materials known to those of ordinary skill in the art. The mounting panel 12 can include a plurality of planar plates 15 constructed and arranged in a grid or array on a sheet. Each plate can receive a planting cell module 18. Alternatively, a planting cell module 18 can be positioned on two or more plates.

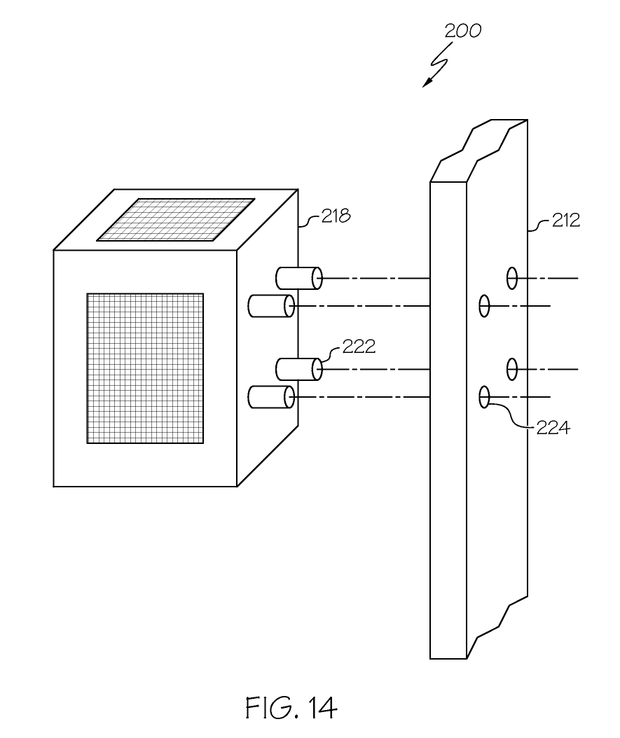

In one embodiment, a plurality of mounting tabs 14, or related male protrusions such as studs, can extend from the mounting panel 12. In another embodiment, as shown in FIG. 14, a mounting panel 212 can have a plurality of holes 224 for receiving and mating with mounting tabs 222 extending from a planting cell module 218. The mounting tabs 14 can be constructed and arranged as an array of rows and columns. One or more mounting tabs 14 can be attached to a planting cell module 18 for holding the planting cell module 18 in a vertical position against the mounting panel 12. In one embodiment, the mounting tabs 14 extend in a direction 90 degrees relative to the surface of the mounting panel 12. In another embodiment, the mounting tabs 14 extend in a direction other than 90 degrees relative to the surface of the mounting panel 12, for example, 60 degrees.

The mounting tabs 18 can have different arrangements. A top row of mounting tabs 14-1 can be constructed and arranged for coupling with the drip pan 50 shown in FIG. 1. A bottom row of mounting tabs 14-2 can be constructed and arranged for coupling with the catch basin 52 shown in FIG. 1. The mounting tabs 14-1, 14-2 of the top and bottom rows, respectively, can have a same or different arrangement than an array of mounting tabs 14 between the top and bottom rows 14-1, 14-2. For example, shown in FIGS. 2A, 2B and 2C, a top row of the mounting panel 12 can have four mounting tabs 14-1, while other regions of the mounting panel 12 can have a row of six mounting tabs 14.

As described herein, the mounting tabs 14, 14-1, 14-2 (generally, 14), are constructed and arranged to mate and interlock with sockets at the rear surface of one or more planting cell modules 18. However, other embodiments are not limited to mounting tabs, but can include other attachment mechanisms for interlocking with one or more planting cell modules 18. For example, as shown in FIG. 14, a mounting panel 212 can include holes 224 instead of mounting tabs and interlock with male mounting tabs 222 extending from a rear surface of a planting cell module 218.

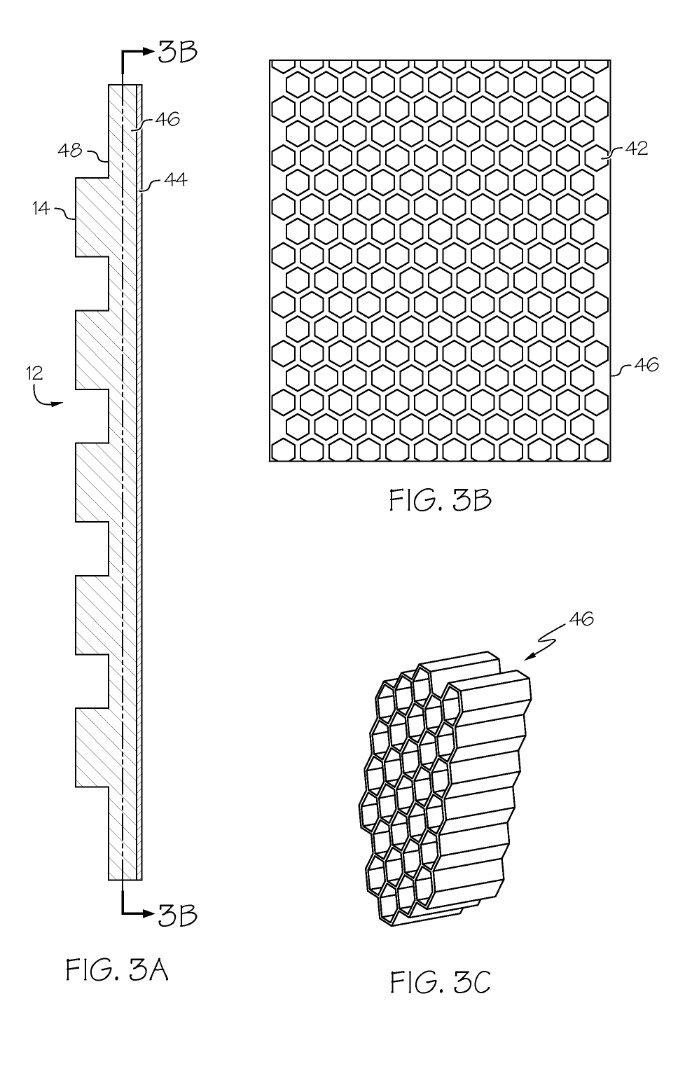

FIG. 3A is a side view of the mounting panel 12 of FIG. 2, in accordance with an embodiment. FIG. 3B is a front view of the mounting panel of FIGS. 2 and 3A, taken along line A-A′. FIG. 3C is a perspective view of a core of the mounting panel of FIGS. 2, 3A and 3B;

As described above, the mounting panel 12 can be molded or machined from well-known materials, such as plastic and/or metal. The back surface of the mounting panel 12 can be substantially flat so that the mounting panel 12 can directly abut a wall or other vertical surface.

The mounting panel 12 can include a core 46 having a honeycomb design 42 between a front 48 and a back 44. The honeycomb design of the mounting board 12 can maintain an air space between a plant cell module 18 and a wall or other surface at which the mounting panel 12 can be positioned. The air space, or void space, can act as a temperature regulator or buffer between the planting cell module 18 and the surface the living wall system is mounted to by mediating, or splitting, a difference between a temperature of the planting cell module 18 and the wall surface. By mediating the temperatures between the two surfaces, the amount of condensation can be reduced. Any condensation that is formed will occur at the core of the mounting board 12 and will not transfer to the mounted wall surface. The mounting tabs 14 can extend from the front 48 of the panel 12. The length and width of the mounting panel 12 can be for commercial design and measured in square inches for the framed design, for example, 12×12 inches, 12×18 inches and 18×24 inches. For irrigation, one or more drip hoses (not shown), for example, 0.25 inch hoses, can be used to provide an irrigation path that extends between the planting cells 18 to irrigate via an emitter. Alternatively, if the plants in the cells 18 are watered manually water, then the water can be gravity fed through the perforated walls of the planting cells 18.

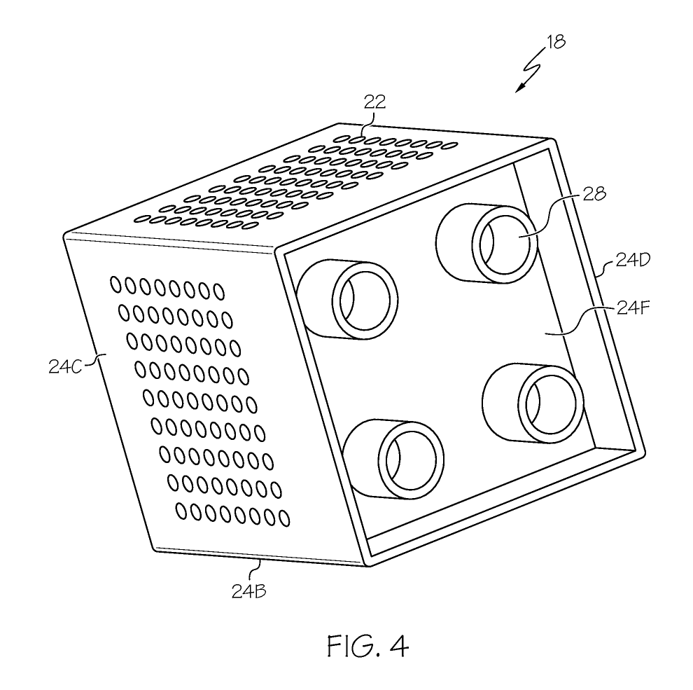

FIG. 4 is a perspective view of a planting cell module 18, in accordance with an embodiment. The planting cell module 18 can be molded or machined from well-known materials, such as plastic.

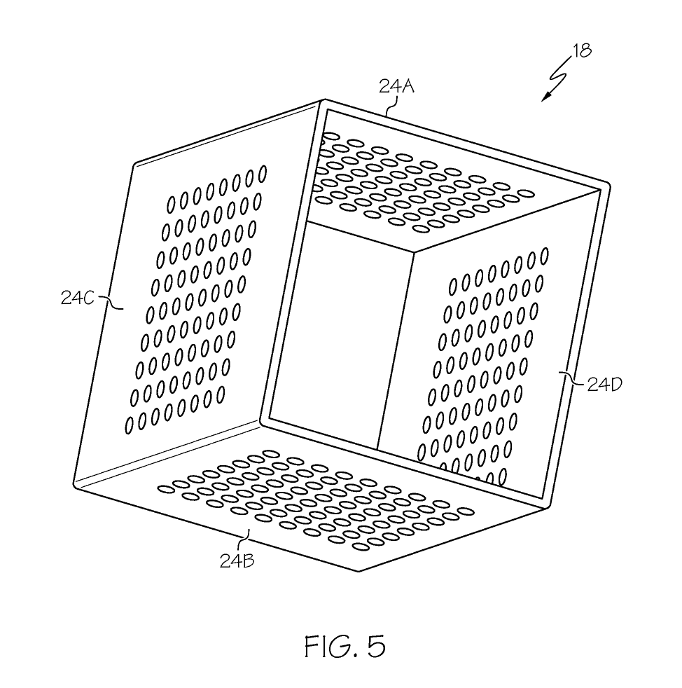

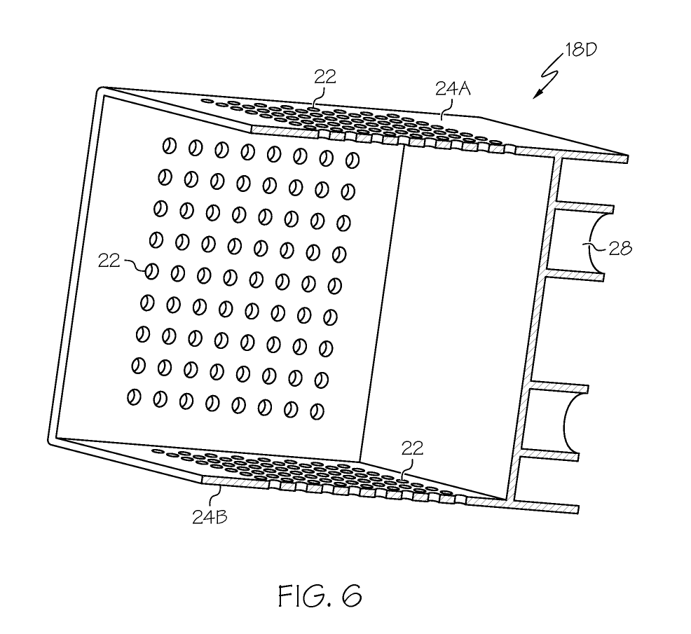

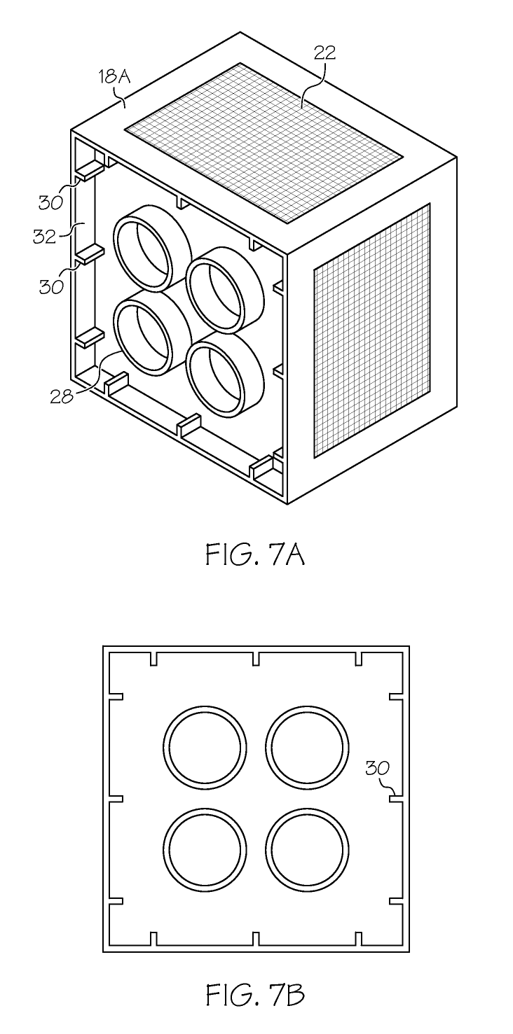

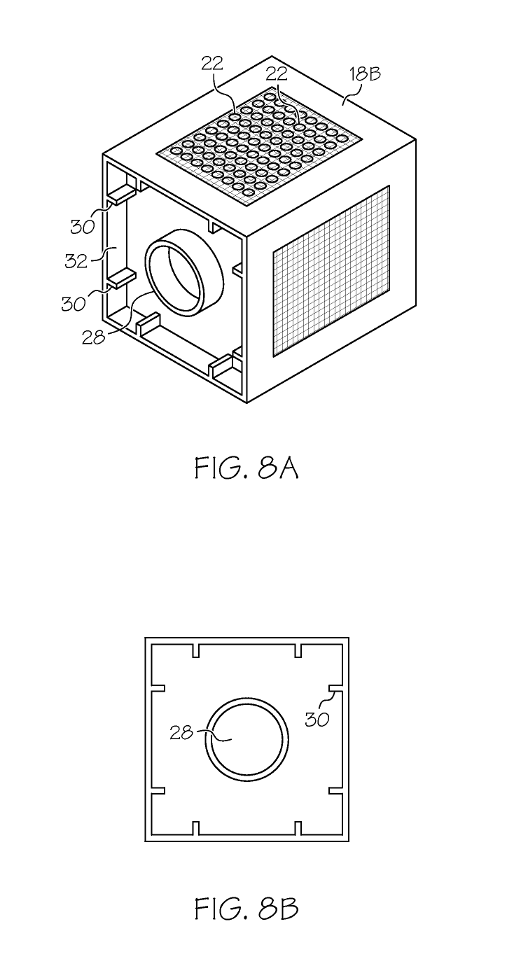

The planting cell module 18, can be cube-shaped and therefore include a top surface 24A, a bottom surface 24B, two side surfaces 24C, 24D, and a rear surface 24F (generally, 24). Other shapes and dimensions can equally apply, for example, i.e., square, rectangular, polygon, and so on. A front region (not shown) of the planting cell module 18 can include an opening for inserting and removing soil, plants, or related organic material. In an embodiment, the top, bottom, and side surfaces 24A-24D form a single integral unit, or body, as shown in FIG. 5. The rear surface 24F can be attached separately. In another embodiment, the top, bottom, side, and rear surfaces 24A-D, F are formed as a single integral unit 18D, as shown in the cutaway perspective view of FIG. 6.

Some or all of the walls 24A-F of the planting cells 18 can include a plurality of small openings 22, for example, perforations, allowing for air, water and microbial exchange. For example, water can be provided from the drip pan 50 to the contents of the planting cell module 18, i.e, soil, plants, or other living organisms, via the openings 22.

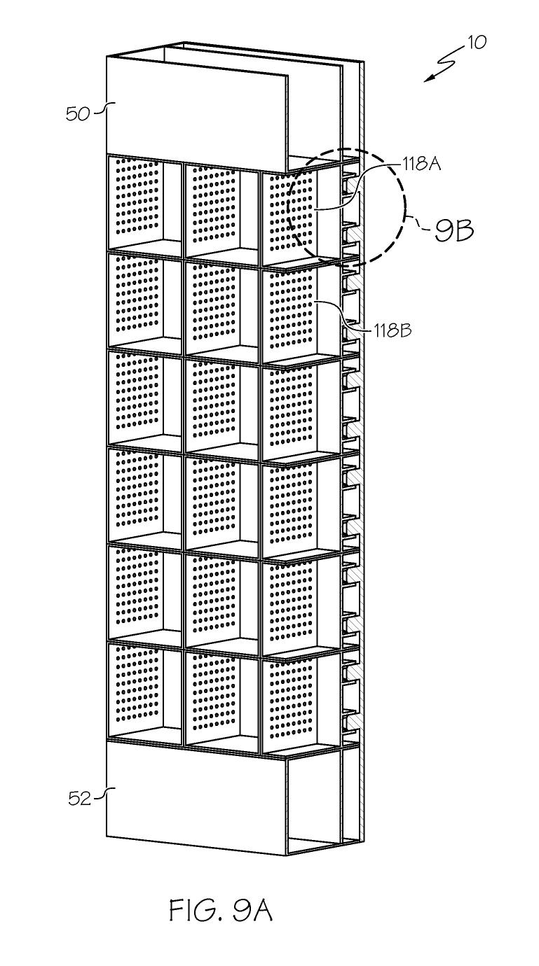

The planting cell module 18 can include at least one socket 28, or a hole or recess, at a rear surface 24F. The number of sockets 28 per planting cell module 18 can dependent on the dimensions of the planting cell module 18. In one embodiment, each side has a length of 4 inches or more. As shown in FIGS. 8A and 8B, a 4 inch planting cell module 18B can have a single socket 28. In another embodiment, each side of a planting cell module 18 has a length of 6 inches or more. As shown in FIGS. 7A, and 7B, a 6 inch planting cell module 18A can have four sockets 28. Each socket 28 is dimensioned for receiving and locking with a mounting tab 14 extending from the mounting panel 12. For example, a socket 28 can have a 0.5 inch diameter, to receive a mounting tab 14 of the panel 12. Different planting cell modules can be attached to the mounting panel 12. For example, a planting cell module 18 from the mounting panel 12 for cleaning, repair or other maintenance, or replacing plants therein, and so on. A planting cell module 18 can be removed from the panel 12, and replaced with different planting cell module 18, for example, a planting cell module having a different configuration, such as a larger planting cell module. Although the figures illustrate mounting tabs extending from a mounting panel that communicate with planting cell module sockets, other configurations can equally apply. For example, a mounting panel 12 can include a plurality of openings, rings, hooks, brackets, or other mechanical attachments, which are removably coupled to openings, rings, hooks, brackets, or other mechanical attachments at a rear surface of a planting cell module 18, which form an interlocking relationship with counterpart attachment mechanisms at the mounting panel 12.

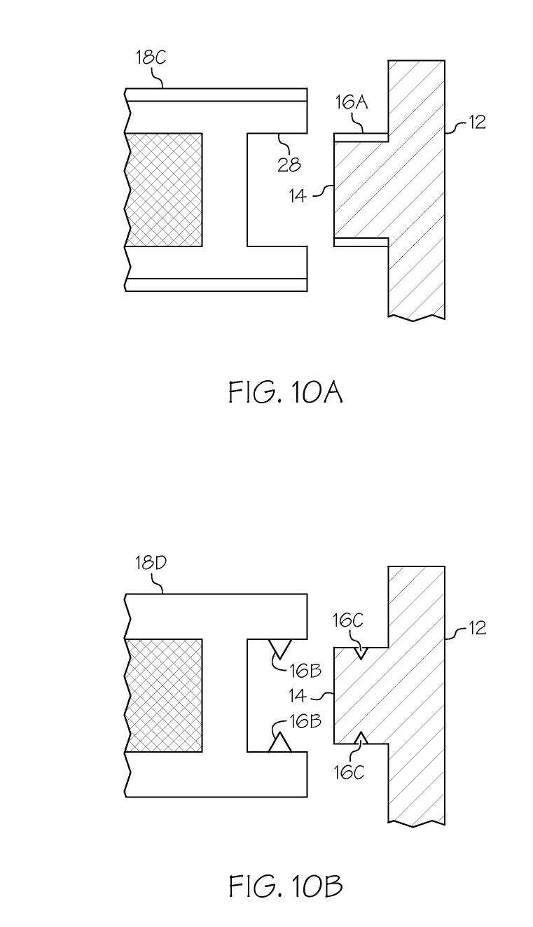

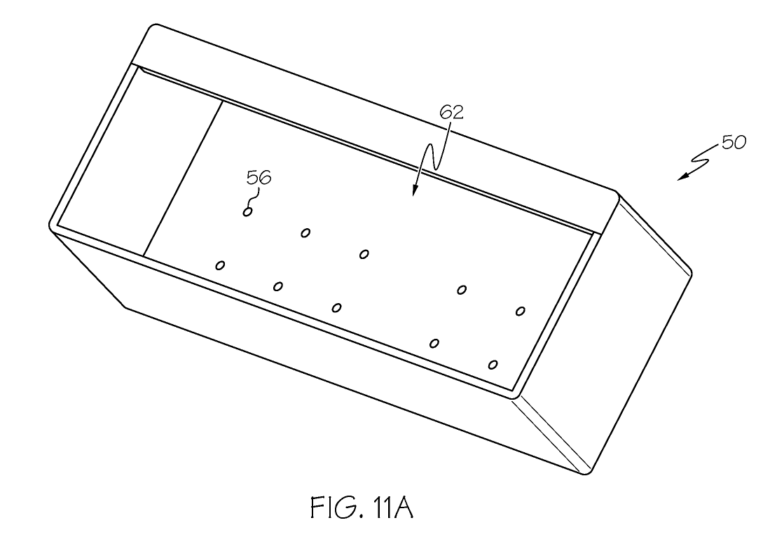

As shown in FIGS. 7A, 7B, 8A, and 8B, a planting cell module 18A, 18B (generally, 18) can include a guide channel 32 defined by two guides 30. As shown in FIGS. 10A and 10B, a locking ridge 16 of the mounting panel 12 can extend through the guide channel 32 to hold the planting cell module 18 in place against the mounting panel 12. In other embodiments, as shown in FIG. 4, a planting cell module 18 does not require guides 30 or guide channels 32. The locking ridges 16 can also be provided for further stabilization, for example, to prevent the cell module 18 from shifting or spinning about the tabs 14.

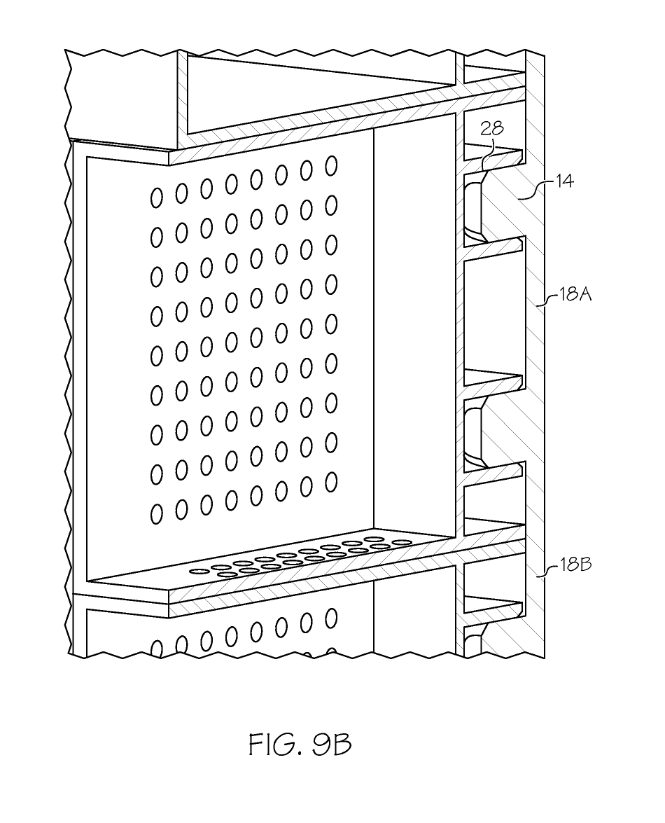

FIG. 9A is a cutaway perspective view of the vertical garden system of FIG. 1, in accordance with an embodiment. FIG. 9B is a cutaway closeup view of the vertical garden system of FIGS. 1 and 9A.

The mounting panel 12 can be configured for receiving a plurality of planting cells 18. Each planting cell module 18 can be removably coupled to the mounting panel 12 by inserting each socket 28 of the planting cell module 18 into a corresponding mounting tab 14 protruding from the mounting board 12. For example, as shown in FIGS. 8A and 8B, a planting cell module 18B can have one hole, or socket 28, which can be inserted into a mounting tab 14. Here, the planting cell module 18D can be square-shaped, with each side having a length of 4 inches or more. In another example, as shown in FIG. 4, a planting cell module 18 can have four holes 28. Here, the planting cell module 18 can be square-shaped, with each side having a length of 6 inches or more. The mounting tabs 14 and corresponding holes 28 can have similar shapes and dimensions, for example, circular, square, hexagon, etc. The dimensions of each number 14 and corresponding socket 28 are similar for securely fitting the mounting tab 14 into the socket 28 to hold the planting cell module 18 in place against the mounting panel 12. In an embodiment, each mounting tab 14 has a diameter of 0.5 inches, and is aligned with a socket 28 or recess in a planting cell module 18 having a similar diameter so that the planting cell module 18 can be secured to the mounting panel 12.

FIG. 10A is a closeup side view of a planting cell module 18C in communication with a mounting tab 14 having a locking ridge 16A, in accordance with an embodiment. FIG. 10B is a closeup side view of a planting cell module 18D in communication with a mounting tab 14 having another locking ridge 16C in accordance with an embodiment. The locking ridge 16C of FIG. 10B can be a groove or the like into which a protrusion 16B or the like can be positioned. The protrusion 16B can be firmly snapped into the locking ridge 16C to engage with the locking ridge 16C.

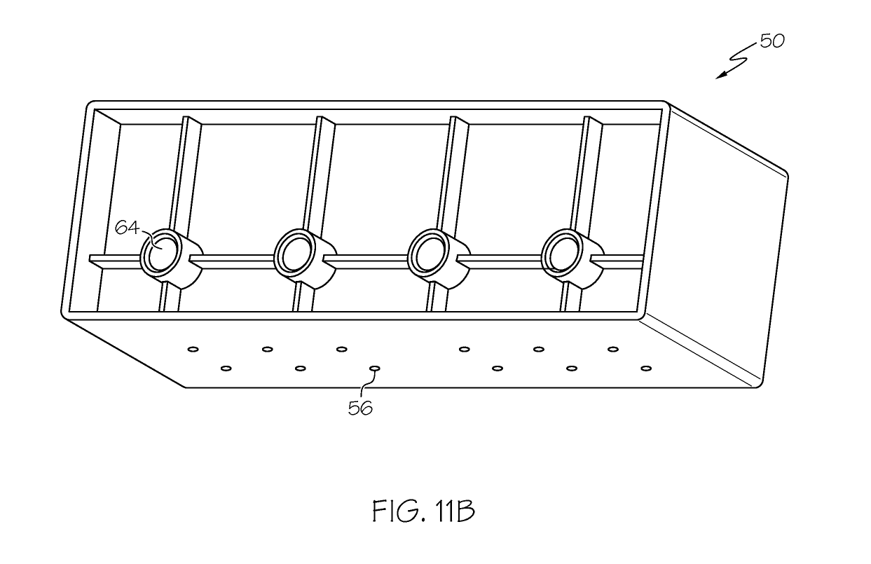

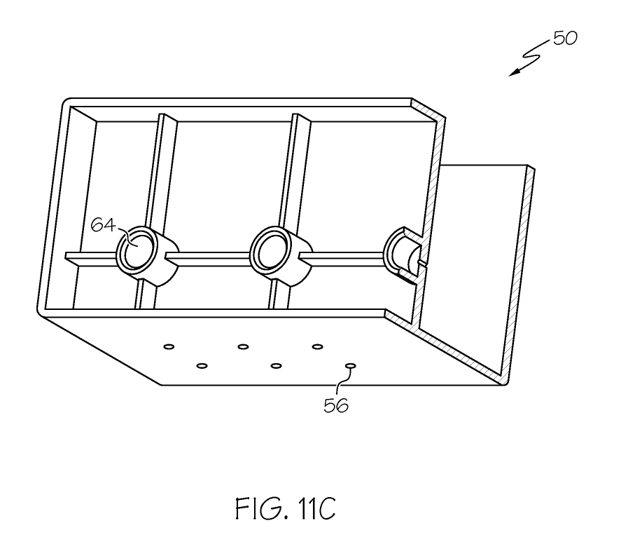

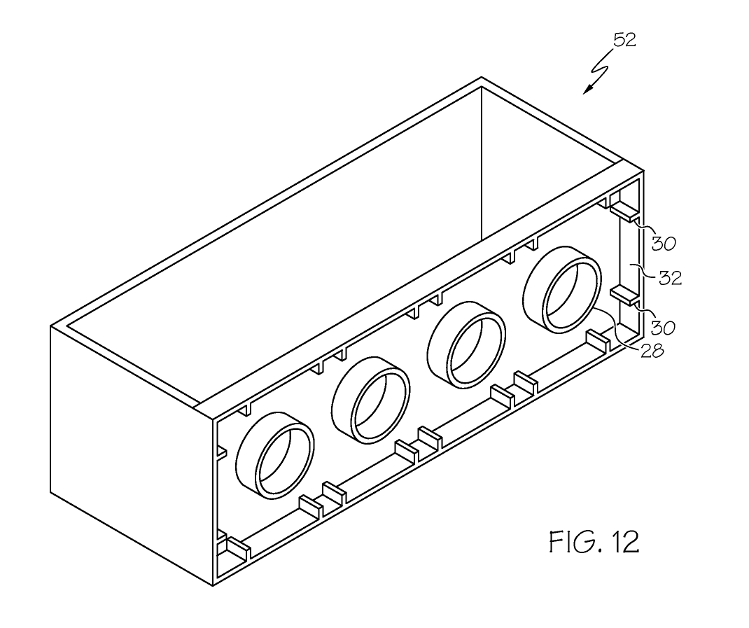

FIG. 11A is a top view of a drip pan 50, in accordance with an embodiment. FIG. 11B is a rear view of a drip pan, in accordance with an embodiment. FIG. 11C is a cutaway rear view of the drip pan of FIGS. 11A and 11B. The drip pan 50 can be molded or machined from well-known materials, such as plastic or metal. The drip pan 50 can have a depth that varies according to design and can have a width that is the same or similar to a width of the wall of the mounting panel 12.The drip pan 50 can be attached to the mounting panel 12 using a same or similar male female locking ridge method as the same mounting tab locking system described with respect to the cell modules.

During operation, as water can be output from an emitter and received at an opening 62 of the drip pan 50. The drip pan 50 can be at least partially filled with water which slowly drips through small weep holes 56 and move through the wall by force of gravity through the perforated sides of the planting cells 18. In this manner, the soil within the walls of the cells 18 can receive the water and become at least partially saturated.

FIG. 12 is a perspective view of a catch basin 56, in accordance with an embodiment. The catch basin 56 can be constructed in a similar manner as the drip pan 50. For example, the rear surface of the catch basin 56 can include sockets 28, guides 30, and/or guide channels 32, similar to the drip pan 50 and/or the planting cells 18 described herein. Details will therefore be omitted for brevity.

The catch basin 56 is positioned at a bottom region of the mounting panel 12, and can collect the excess water not received by plants and/or soil in the cells 18 above the catch basin 56. The water that collects in the catch basin 56 can be discarded in a well-known manner, for example, by emptying the water in the catch basin 56.

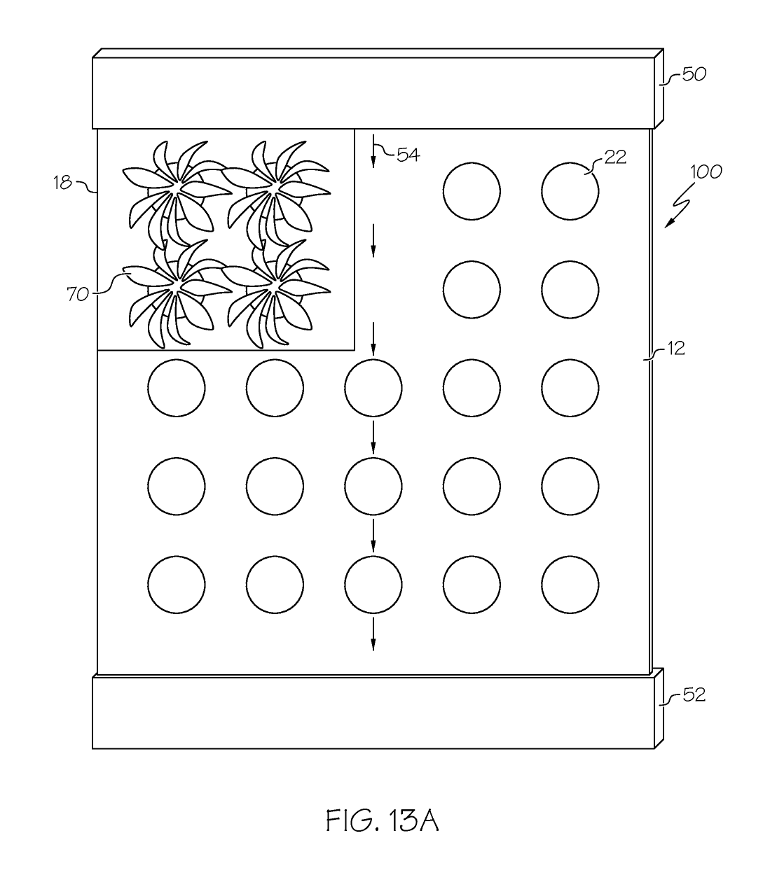

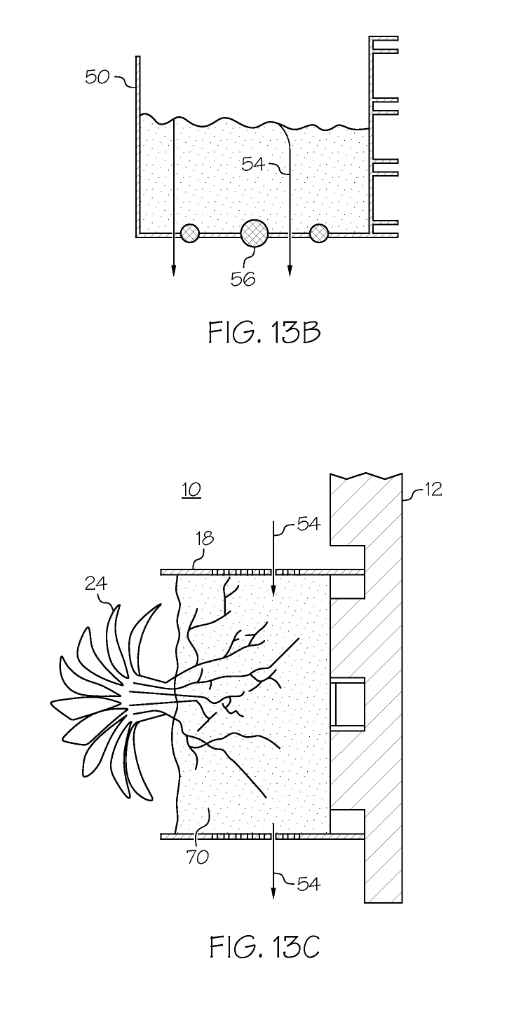

FIG. 13 is a front view of a vertical garden system 100 in which water 54 flows through elements of the vertical garden system. FIG. 13B is a cross-sectional front view of a drip pan 50 in which water is collected, wherein a portion of the water is removed from the drip pan 50 via a plurality of weep holes, in accordance with an embodiment. FIG. 13C is a cross-sectional side view of the vertical garden system 100, in accordance with an embodiment.

In particular, water 54 collects in the drip pan 50 and is output via weep holes 56 to the planting cells 18 attached to the mounting panel 12. The catch basin 52 can collect the excess water that is not otherwise absorbed by the plants 70, soil, or other organic components in the cells 18.

While the invention has been shown and described with reference to specific embodiments, it should be understood by those skilled in the art that various changes in form and detail may be made therein without departing from the spirit and scope of the invention.

What is claimed is:

1. A vertical garden system, comprising:
a mounting panel, the mounting panel including a plurality of first mounting attachment mechanisms; and
a planting cell module positioned on a surface of the mounting panel, the planting cell module having a second mounting attachment mechanism constructed and arranged for removably coupling with a first mounting attachment mechanism of the plurality of first mounting attachment mechanisms, the planting cell module having an interior volume in which a plant component is positioned.

2. The vertical garden system of claim 1, wherein the second attachment mechanism of the planting cell module includes four sockets at a rear surface of the planting cell module, each socket constructed and arranged for removably coupling with a mounting tab of the plurality of first attachment mechanisms.

3. The vertical garden system of claim 1, wherein the plant component includes at least one of a plant, a pregerminated seed, and soil positioned in the interior volume of the planting cell module.

4. The vertical garden system of claim 1, wherein the plant component includes a plant that extends from an opening of the planting cell module opposite the socket.

5. The vertical garden system of claim 1, wherein the mounting panel is attached to a vertical surface, and wherein the planting cell module extends in a horizontal direction from the surface of the mounting panel.

6. The vertical garden system of claim 1, wherein a plurality of planting cell modules are removably coupled to the mounting panel, and are arranged on the mounting panel in an array.

7. The vertical garden system of claim 1, further comprising a drip pan coupled to a top region of the mounting panel above the planting cell module for providing water to the plant component in the planting cell module.

8. The vertical garden system of claim 1, further comprising an irrigation path that extends from the drip pan to the planting cell module.

9. The vertical garden system of claim 1, further comprising a catch basin coupled to a bottom region of the mounting panel below the planting cell module for receiving excess water from the planting cell module.

10. The vertical garden system of claim 1, further comprising an irrigation path that extends from the planting cell module to the catch basin.

11. The vertical garden system of claim 1, wherein the mounting panel comprises a front surface, a back surface, and a core between the front and back surfaces that regulates root zone temperatures and eliminate condensation.

12. The vertical garden system of claim 1, wherein the planting cell module comprises a locking ridge that holds planting cell module in place against the mounting panel.

13. The vertical garden system of claim 1, further comprising a decorative frame coupled to a perimeter of the mounting panel.

14. The vertical garden system of claim 1, wherein the first mounting attachment mechanism includes a hole in the mounting panel and the second mounting attachment includes a male tab that extends from the planting cell module for mating with the hole in the mounting panel.

15. A planting cell module, comprising:
a cube-shaped body, the body including a rear surface and an exposed front region opposite the rear surface;
at least one first attachment mechanism at the rear surface that is constructed and arranged for removably coupling with a second attachment mechanism at a mounting panel; and
and an interior volume in the body, a plant component positioned in the interior volume.

16. The planting cell module of claim 15, wherein the plant component grows out of the front region of the body.

17. The planting cell module of claim 15, wherein the first attachment mechanism includes a socket and the second attachment mechanism includes a mounting tab.

18. The planting cell module of claim 15, wherein the first attachment mechanism includes a mounting tab and the second attachment mechanism includes a socket.

19. A method for forming a living wall, comprising:
positioning a mounting panel at a wall, the mounting panel including a plurality of first attachment mechanisms;
coupling a planting cell module to at least one first attachment mechanism of the plurality of mounting tab, the planting cell module having at least one second attachment mechanism that communicates with the at least one first attachment mechanism for holding the planting cell module in place against the mounting panel; and
positioning a plant component in an interior volume of the planting cell module, at least a portion of the plant component extending in a direction that is transverse with respect to the mounting panel and that is viewed from an opening of the planting cell module.

20. The method of claim 19, further comprising:
removing the planting cell module from the mounting panel; and
replacing the planting cell module with a different planting cell module or performing maintenance on the planting cell module.
